(19) United States
(12) Patent Application Publication
(10) Pub. No.: US 2021/0146558 A1
(43) Pub. Date: May 20, 2021

(54) RESCUE WIRE CUTTER

(71) Applicant: Chad Joseph Shaffer, Santa Maria, CA (US)

(72) Inventor: Chad Joseph Shaffer, Santa Maria, CA (US)

(21) Appl. No.: 16/689,791

(22) Filed: Nov. 20, 2019

(51) Int. Cl. B26B 13/26; B25B 13/28

(52) U.S. Cl. CPC B26B 13/26; B25B 13/28

(57) ABSTRACT

The invention relates generally to a hand operated wire cutting tool that can perform multiple functions. More so the invention relates to the fire service tasks of cutting wire(s) in a confined space with limited movement, feel and visibility. The said invention is a new functional tool that dramatically increases the efficiency to cut wire(s) and/or cuttable objects in the negative and challenging conditions of confined spaces and/or entrapment situations with zero visibility. The invention uses two or more guides that directly contact wire(s) and direct them into the cutting area. The wire(s) contacts the guides and then enters the cutting area on the proximal and/or user side of the invention; this allows for the invention user to easily locate wire(s) with the length of their arm and direct wire(s) into the invention's cutting area with simple directional movement of the invention towards the user. By adducting the invention toward the user, the wire(s) move across the user's arm toward the guides of the invention and straight into the cutting area of the invention.

### CROSS-REFERENCE TO RELATED APPLICATIONS

This application is based on and claims the benefit of priority of U.S. Provisional Patent Application No. 62/770,137, filed on Nov. 20, 2018.

### FIELD OF INVENTION

The invention relates generally to a hand operated wire cutting tool that can perform multiple functions. More so, the invention relates to the fire service task of cutting wire(s) while in confined spaces with limited movement and/or visibility. The said invention is a new functional tool that dramatically increases the efficiency and ability to cut wire(s) and/or obstructions in the negative and challenging conditions of confined spaces and/or entrapment situations while having zero visibility.

### BACKGROUND OF THE INVENTION

Firefighters and rescue personnel use the typical style wire cutters with an open distal end to attempt to free themselves from wire entanglement in confined spaces. Wires have a high percentage of becoming entangled and/or caught on self-contained breathing apparatus parts, firefighter helmet parts, equipment worn by the firefighter, and the firefighter's extremities while working in confined spaces. Firefighters are typically moving in the prone and/or supine position through confined spaces, this position of travel creates a slow speed of movement; furthermore, movement, feel, and visibility are all diminished due to equipment worn and conditions of the environment the firefighter is working in. Firefighters are usually racing against time to safely extricate victims and/or themselves due to the area's dangerous environmental conditions and limited self-contained breathing apparatus (SCBA) air supply. Firefighters have died and/or become injured in confined spaces due to running out of SCBA air while entangled in wires; furthermore, wire entanglement has been proven to be the direct cause of some firefighter line of duty fatalities. The high threat level of entanglement to firefighters is real and may be encountered during all aspects of structural firefighting, aircraft firefighting, ship firefighting, confined space rescue, and many other fire service emergency response types. Current solutions and preventative methods for firefighter and equipment entanglement rely on the firefighter to attempt to guide, untangle, cut or unhook wires by hand; these solutions are not always successful because firefighters may be in a confined space that does not allow for proper movement to guide and/or detangle wires from themselves and/or equipment; furthermore, visibility may be limited or completely absent due to surrounding conditions, therefore directly affecting the user's ability to see cutting tools and place the cutting area of the cutting tool on or around the wire(s) caught. Current wire cutters have no guide or component to help guide non visible wire(s) quickly and sufficiently into the cutting area; furthermore, the emotional state and ability to remain calm and think clearly is a challenge for firefighters who become entangled with objects. Panic may occur and diminish the user's ability to methodically go through multiple steps to free themselves. As a last result, current solutions rely on firefighters to blindly cut caught/entangled wires with no wire guidance help from the structural design of the wire cutting tool itself; furthermore current wire cutting tool design causes an extreme high level of difficulty to blindly cut wires with the use of only one hand, one hand is needed to operate the wire cutters and the other hand is used to locate and hold a portion of the entangled/caught wire. The International Association of Fire Fighters (IAFF) promotes a training course entitled “Fire Ground Survival” (FGS). The FGS course teaches techniques to prevent firefighters and their equipment from becoming entangled with objects and what to do if an entanglement occurs, but these solutions are similarly unable to meet the needs of the industry, because they rely solely on the firefighter to function methodically in poor and/or uncomfortable conditions, under high stress with a high risk for human error. Suspended ceilings that have collapsed create a high threat for objects, most commonly wires to become caught on the SCBA. The current SCBA design does not meet the industry needs to prevent and/or prohibit entanglement with objects; furthermore the last ditch effort to free one's self from these entanglements relies on wire cutting tools that lack structural components and/or functional design to aid the user in cutting wires single handedly and/or blindly.

There currently exists a need in the industry for a wire cutting tool with structural design and functionality that helps facilitate objects to move directly into the cutting area of the wire cutting tool with simplicity and the use of only one hand while in zero visibility. It would be highly desirable to have the structural components, design and functionality of the said invention to help locate and guide wires into the cutting area of the said invention; furthermore the use of only one hand to accomplish this in zero visibility would also be extremely desirable. The wire guides and cutting area opening of the said invention would allow for faster contact times between the wire cutting surfaces of the invention and wires to be cut, as well as only having to use one hand to locate, hold and cut wires; furthermore this would allow for quicker de-tanglement with wires and/or cuttable objects while providing a better chance of firefighter egress and survivability.

### SUMMARY OF THE INVENTION

Disclosed is the said invention, broadly comprising of: two individual cutting surfaces; two user handles with at least one user handle that gives motion to at least one individual cutting surface; at least one fastener/pivot devices; at least two guides for directing wire(s) and/or cuttable objects into the cutting area. These components are related and/or connected as follows; at least one of the two individual cutting surfaces will have movement towards the other cutting surface by the movement of at least one handle. Each handle comprises of a proximately terminating end and a distal terminating end that terminates into a cutting surface. One handle will structurally form a first guide that terminates into a cutting surface that then terminates into a second guide. Each handle has at least one pivot axis disposed between the proximal end of the handle and the distal cutting surface that the handle terminates into. The fastener/pivot device will pivotably connect components together and hold them in place when placed through the pivot axis. The guides will protrude/extend away from the cutting surface/area in a manner that allows the guides to make direct contact with wire(s) outside of the cutting area and guide them into the cutting area by simple movement of the said invention toward the user. A tension/friction mechanism to keep the cutting area in the open position to more easily allow wires to enter between the cutting surfaces is highly desirable, but not needed to allow the said invention to function properly.

The function of the disclosed invention is unique when compared with other known devices and solutions because it provides: users to benefit from a hand operated cutting tool with a functional design that helps locate and guide wire(s) into the cutting area of the cutting tool with one hand and/or in zero visibility; Aids users in feeling wire(s) as well as guiding wire(s) into the inventions open cutting area and then isolates/secures wire(s) in the open cutting area; Guides wires into the cutting area by contacting the wire side furthest away from the user; Simple adduction of the said invention toward the user allows reachable wires to be guided into the cutting area of said invention; Allows for simpler and quicker egress while crawling through confined spaces with the possibility of wire entanglement if entanglement occurs; Allows users to carry less individual tools when the said invention is structurally designed with multi-tool components, thus allowing users to more readily locate and keep tools stored on their person and/or equipment; Will dramatically help saves lives of said invention users and others who may be rescued by said invention users in environments that pose a threat for wire entanglement.

The disclosed invention is unique in that it is structurally different from other known devices or solutions. More specifically, the device is unique due to the presence of: At least two guides that protrudes/extends away from the cutting surfaces/area and terminates in the proximal direction of the said invention and guides wire(s) and/or cuttable objects to move into the cutting area from the proximal/user side of the said invention; The closed distal end opposite from the user that forms a dead end in the cutting area; The guides, handles, cutting surfaces and/or cutting area may structurally form and function as valve wrenches, hook(s) for hanging and/or holding objects, attachment point(s), prying tool(s), striking/hammer type tool(s), spanner wrench(s), window breaking tool(s), fire hydrant wrench(s), fire sprinkler head wedge(s) and/or a rope rescue friction descending device to create a multi tool.

Among other things, it is an object of the present invention to provide a new cutting tool for firefighter entanglement that does not suffer from any of the problems or deficiencies associated with previous solutions.

### BRIEF DESCRIPTION OF THE DRAWINGS

FIG. 1.—Illustrates the said invention disassembled into its three major components.

FIG. 2.—Illustrates the assembled said invention components with the cutting area of the said invention in an open position.

FIG. 3.—Illustrates the assembled said invention components with the cutting area of the said invention closed as if it was cutting.

FIG. 4.—Illustrates multi-tool components of the said invention used for purposes other than cutting. Six of the seven basic said invention components are illustrated with multi-tool components. The fastener/pivot device is the seventh basic component that is not illustrated. Two of the three major components of the said invention are illustrated, the fastener/pivot device is the major component not illustrated. The two major components illustrated are not assembled to one another and are viewed side by side.

FIG. 5.—Illustrates multi tool components of the said invention used for purposes other than cutting. Six of the seven basic said invention components are illustrated with multi-tool components. The fastener/pivot device is the seventh basic component that is not illustrated. Two of the three major components of the said invention are illustrated, the fastener/pivot device is the major component not illustrated. The two major components illustrated are not assembled to one another and are viewed side by side.

FIG. 6.—Illustrates the path of travel for a wire to be cut as the said invention user adducts the said invention towards themself.

FIG. 7.—Illustrates rope rescue friction descending device components of the said invention with the cutting area in an open position.

FIG. 8.—Illustrates rope rescue friction descending device components of the said invention with the cutting area closed.

FIG. 9.—Illustrates the said invention with the cutting area closed and said invention components structurally forming a fire hydrant wrench and/or rope rescue friction descending device.

FIG. 10.—Illustrates the said invention with the cutting area open and said invention components structurally forming a rope rescue friction descending device.

### DETAILED DESCRIPTION OF THE INVENTION

The invention will now be described more fully hereinafter with reference to the accompanying drawings, which are intended to be read in conjunction with both this summary, the detailed description and any preferred and/or particular embodiments and variations specifically discussed or otherwise disclosed. This invention may, however, be embodied in many different forms and should not be construed as limited to the embodiments set forth herein; rather, these embodiments are provided by way of illustration only and so that this disclosure will be thorough, complete and fully conveys the full scope of the invention to those skilled in the art.

In its most complete version the said invention broadly comprises of seven basic components that create a handheld cutting tool and multiple components that structurally form and function as multiple tools not needed and/or used for cutting. The seven basic components of the said invention that create a handheld cutting tool broadly comprises of two individual handles; two individual cutting surfaces; at least one pivotably connecting device; and at least two guides for directing wire(s) and/or cuttable objects into the cutting area. A tension/friction mechanism to keep the cutting area open when not cutting is highly desirable, but is not needed for the said invention to function properly. Components that structurally form multiple tools non-related to cutting, broadly comprise of two parallel structures to structurally form an opening to be used as a utility meter gas valve shut off tool; Structural design of the guides and/or handles to be used as a spanner wrench to tighten and/or loosen hose couplings; Structural design of at least one component that structurally forms a point for breaking glass; Structural design of at least one component that structurally forms a prying tool; Structural design of at least one component that structurally forms a striking/hammer tool; Structural design of at least one component that structurally forms a rope rescue friction descending device; Structural design of at least one component that structurally forms a wedge for stopping water flow from a fire sprinkler head; Structural design of at least one component that structurally forms a fire hydrant wrench.

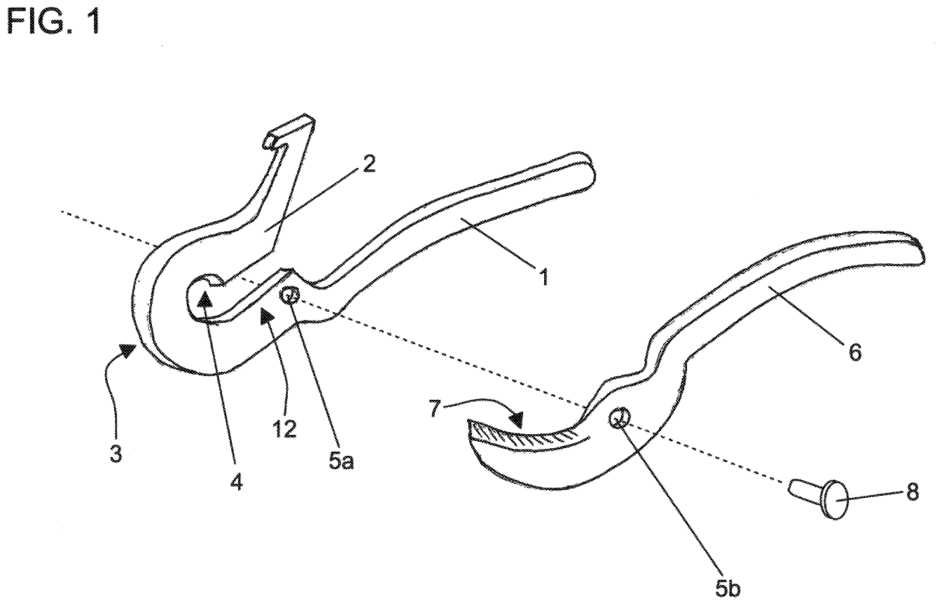

FIG. 1 illustrates seven basic components that structurally form the said invention, as well as how they are positioned, related and/or connected. Referring to FIG. 1, the seven basic components include handle one (1), handle two (6), cutting surface one (4), cutting surface two (7), guide one (2), guide two (12) and the fastener/pivot device (8); furthermore these seven basic components structurally form three major components that assemble into the said invention.

Referring to FIG. 1, handle one (1) is designed to be held in the user's hand, this end of handle one (1) is the proximal end. Handle one (1) continues distally past the point of the fastener/pivot device hole (5a); Furthermore, at the point of the fastener/pivot device hole (5a), handle one (1) continues and terminates into cutting surface one (4). The distal structural design of handle one (1) between the fastener/pivot device hole (5a) and cutting surface one (4) structurally forms a horizontal “U” shape that creates a closed distal end (3). The closed distal end (3) provides a stopping point for wire(s) to be cut by forming a dead end in the said invention's cutting area. Cutting surface one (4) terminates into guide one (2) and handle one structurally forms guide two (12). Wire guide one (2) begins at cutting surface one (4) and extends toward the proximal end of the said invention and/or in the opposite direction of handle one (1). Guide two (12) is structurally formed by handle one (1) and begins at cutting surface one (4) and extends toward the proximal side of handle one (1). Handle one (1), cutting surface one (4), guide one (2), and guide two (12) structurally form one of the three major components of the said invention.

Referring to FIG. 1, Handle two (6) is designed to be held in the user's hand, this end of handle two (6) is the proximal end. Handle two (6) continues past the point of the fastener/pivot device hole (5b); furthermore at the point of the fastener/pivot device hole (5b), handle two (6) continues and terminates into cutting surface two (7). Handle two (6) and cutting surface two (7) structurally form one of the three major components of the said invention.

Referring to FIG. 1, the fastener/pivot device (8) is designed to pass through the fastener/pivot device holes (5a) (5b). The fastener/pivot device (8) is one of the three major components of the said invention and a basic component. Referring to FIG. 1, the fastener/pivot device (8) is of a rivet design, but will not be limited to this design and may be broadly comprised of multiple components that secure it in place. The fastener/pivot device (8) may also broadly comprise of components that use tension and/or friction for purpose of keeping the cutting area open, thus allowing wire(s) and/or cuttable objects to easily enter the cutting area until handle one (1) and handle two (6) are operated by the said invention user. The fastener/pivot device (8) pivotably connects components together.

Referring to FIG. 1, the major component comprising of basic components handle one (1), cutting surface one (4), guide one (2), and guide two (12) is pivotably connected to the second major component comprising of basic components handle two (6) and cutting surface two (7) by the third major component the fastener/pivot device (8). The fastener/pivot device (8) passes through fastener/pivot device holes (5a) (5b). FIG. 1 illustrates the fastener/pivot device (8) as a rivet style, once placed through the fastener/pivot device holes (5a) (5b), the fastener/pivot device (8) is then compressed to form two rivet heads; furthermore, this process securely assembles all three major components together. The fastener/pivot device holes (5a)(5b) are a pivot axis disposed between the handles and the cutting surfaces.

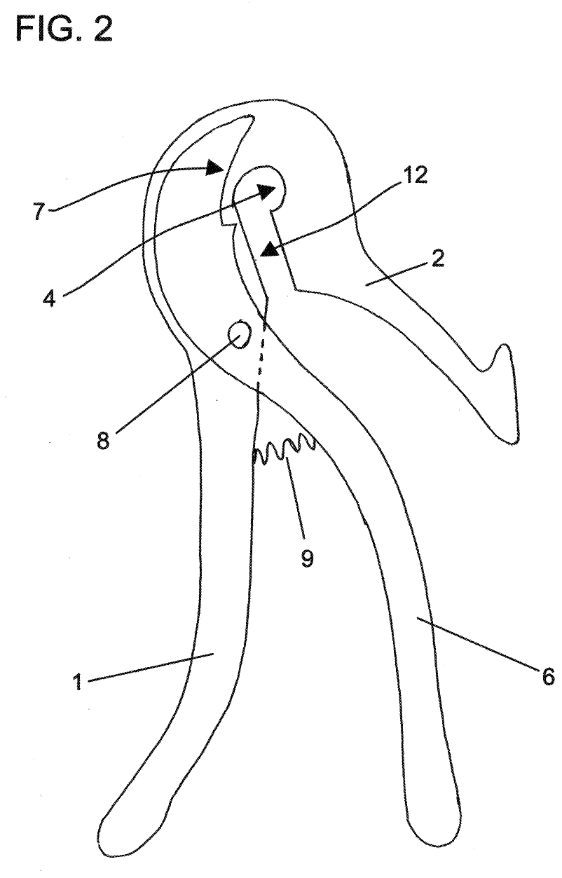

FIG. 2. illustrates the said invention assembled and the cutting area in the open position; furthermore cutting surface one (4) and cutting surface two (7) are each represented by an individual arrowed guide line pointing to the surfaces. Referring to FIG. 2, the cutting area is located between cutting surface one (4) and cutting surface two (7); furthermore the cutting area is considered in an open position when a wire and/or cuttable object has the ability to occupy space between cutting surface one (4) and cutting surface two (7). Wire(s) in contact with guide one (2) and guide two (12) can be directed and stayed in the open cutting area by moving the said invention in the direction of handle one (1) and handle two (6) proximal ends and/or the user; furthermore, this movement is adducting towards the user. Handle spring (9) is a tension/friction mechanism and keeps the cutting area in the open position by pushing handle one (1) and handle two (6) away from each other. A tension/friction mechanism allows the said invention user to move at least one cutting surface to create a closed cutting area when at least one handle is hand operated.

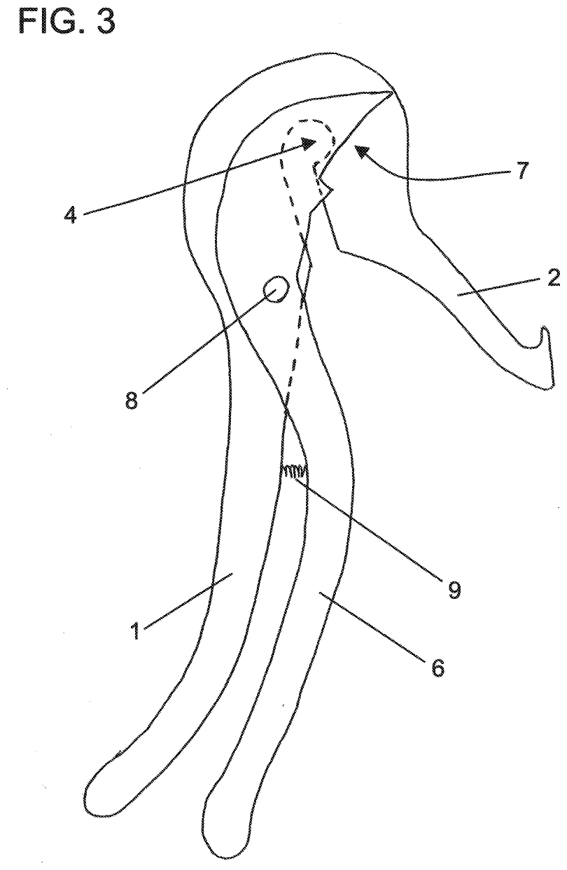

FIG. 3. illustrates the said invention assembled and the cutting area in the closed position; furthermore cutting surface one (4) and cutting surface two (7) are each represented by an individual arrowed guide line pointing to the surfaces. Referring to FIG. 2, moving handle one (1) and handle two (6) towards each other closes the cutting area by moving cutting surface two (7) towards cutting surface one (4). The location and use of the pivotably connection by the fastener/pivot device (8) causes cutting surface two (7) to move towards cutting surface one (4) when handle two (6) is moved towards handle one (1). The handle spring (9) is compressed by the said invention user hand operating the said invention.

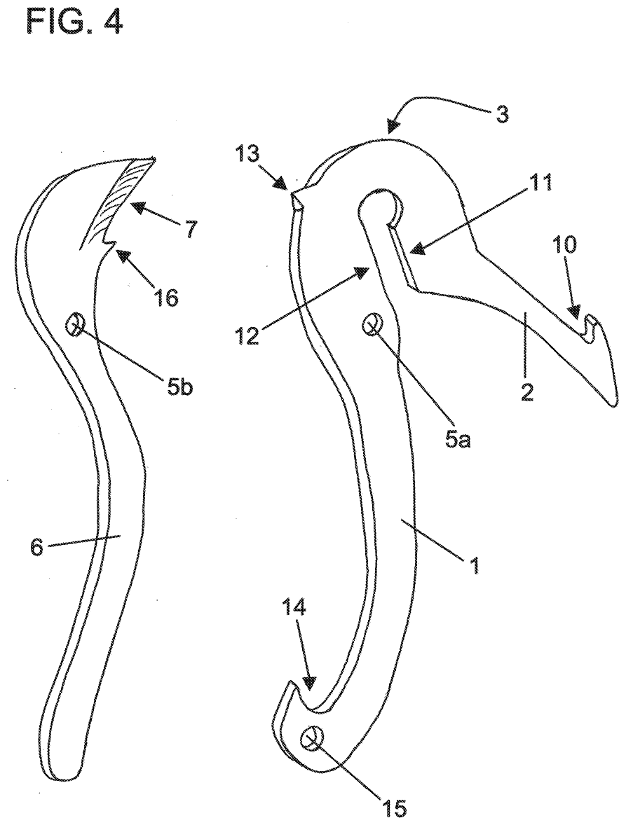

FIG. 4. illustrates two of the three major components of the said invention side by side and unassembled with structural design to form multi-tool components. The fastener/pivot device (8) of FIG. 1 is the major component left out of FIG. 4. Multi-tool components illustrated in FIG. 4 include a wire stop, attachment point, hand stop, pry tool, spanner tool, window punch, gas valve wrench, and a hook.

Referring to FIG. 4, the wire stop (16) is a triangular protrusion at the end of cutting surface two (6) on the fastener/pivot device hole (5b) and/or proximal side of cutting surface two (7). The wire stop (16) ramps up to a peak at a low angle on the fastener/pivot device hole (5b) side; furthermore this low angle design allows wire(s) and/or objects to easily move over the peak without becoming caught on the fastener/pivot device hole (5b) side of the wire stop (16). The cutting surface two (7) and/or distal side of the wire stop (16) is a high angle, this high angle between the wire stop (16) peak and cutting surface two (7) allows wire(s) to become caught on the cutting surface two (7) side of the wire stop (16) peak and holds wire(s) on cutting surface two (7) while cutting. The function of the wire stop (16) is to stop wire(s) from backing out of the cutting area while cutting surface two (7) moves towards cutting surface one (4) during the cutting process.

Referring to FIG. 4, the attachment point hole (15) is located at the proximal end of handle one (1). The primary use of the attachment point hole (15) is for attaching the said invention to an object and/or person. FIG. 4 illustrates an attachment point hole (15) that is intended to accept a rope rescue carabiner; however the attachment point hole (15) will not be limited to this location, size and/or design. The said invention will not be limited to one attachment point hole and may have multiple attachment point holes. Attachment point holes may have multiple functions other than being used as an attachment point.

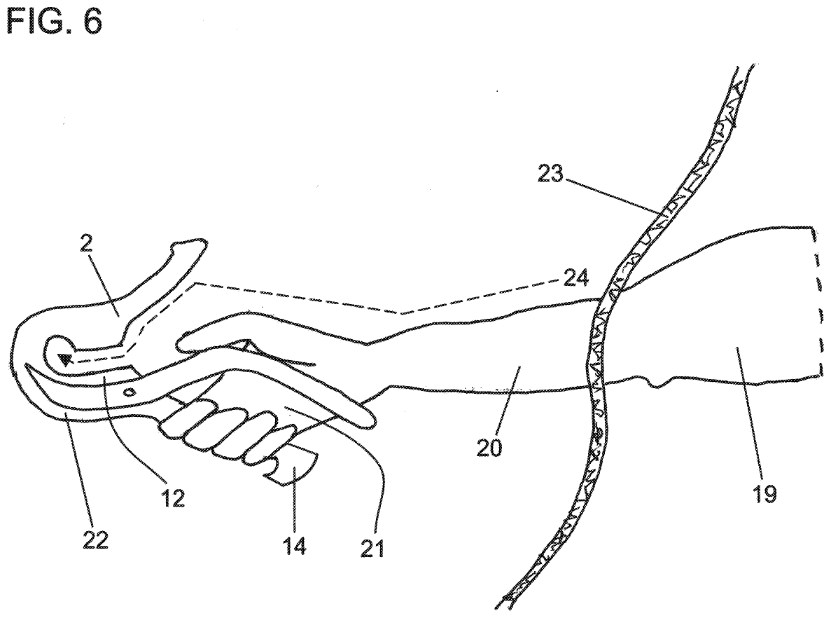

Referring to FIG. 4, the proximal end of handle one (1) structurally forms a hand stop (14). The hand stop (14) prevents the user's hand of the said invention from slipping off of handle one (1) and/or prevents the said invention from slipping out of the user's grip. The hand stop (14) allows for a better user grip by physically contacting the area of the user's hand closest to the hand stop (14). FIG. 6 illustrates the physical contact between the said invention user's hand (21) and the hand stop (14); furthermore FIG. 6. Illustrates the physical functionality of the hand stop (14) and how the hand stop (14) helps to prevent the said invention from being pulled from the user's grip. The hand stop (14) will not be limited to the structural design of FIG. 4 and FIG. 6 and may be of any shape and/or size, quantity, or have multi-purpose functionality; furthermore, multi-purpose functionality of the hand stop (14) may be, but not limited to a pry tool, spanner wrench, attachment point, or wedge component for purpose of blocking a fire sprinkler head orifice to stop water flow from the fire sprinkler head.

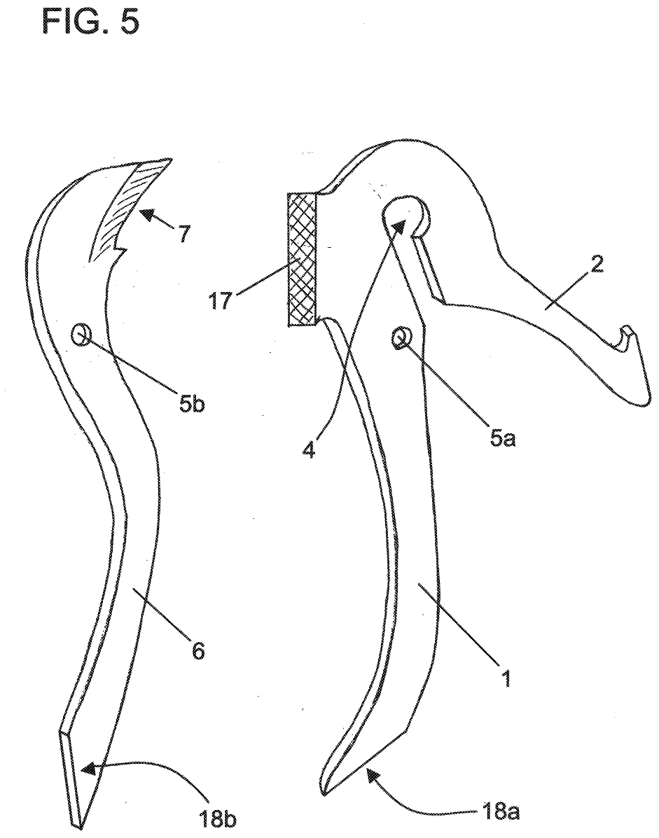

The said invention may broadly comprise of one or more prying tools and/or spanner wrench tool components. Prying tool components may have multiple tool functions other than being used as a prying tool only. Prying tool components may also function as a spanner wrench and vice versa, but will not be limited to a prying tool/spanner wrench multi tool component. Referring to FIG. 4, the hand stop (14) and handle one (1) structurally forms a prying tool; furthermore, the hand stop (14) and handle one (1) also structurally forms a spanner wrench used to loosen and tighten couplings. FIG. 4 illustrates guide one (2) structurally forming multi tool components used for functionality other than guiding wire(s) and/or cuttable objects into the cutting area of the said invention. Referring to FIG. 4, handle one (1), the distal structural edge of guide one (2) and cutting surface one (4), structurally forms a spanner wrench tool. The coupling rocker lug catch (10) catches on the rocker lug of a coupling and allows the said invention user to tighten and/or loosen the coupling by moving handle one (1) in the direction opposite of guide one (2). For the coupling rocker lug catch (10) to work, the coupling must be on the side of guide one (2) opposite from the side that contacts and guides wires directly into the cutting area of the said invention. The coupling rocker lug catch (10) may also structurally form a prying tool and have multi tool functionality. The structural shape of guide one (2) may allow it to function as a wedge component for the purpose of blocking a fire sprinkler head orifice to stop water flow from the fire sprinkler head. FIG. 5 illustrates prying tools structurally formed by the said invention handles. Referring to FIG. 5, pry tool one (18a) and pry tool two (18b) are structurally formed wedge shaped components to be used as prying tools. Pry tool one (18a) is structurally formed at the proximal end of handle one (1) and pry tool two (18b) is structurally formed at the proximal end of handle two (6).

FIG. 4 illustrates a window punch tool located on the distal structural edge of handle one (1) in the area between the closed distal end (3) and the fastener/pivot device hole (5a). The window punch (13) structurally forms a point for the purpose of striking and breaking glass. Guide one (2) may also be structurally designed to be used as a window punch tool. A window punch tool will not be limited to quantities or any specific area and/or location of the said invention.

The said invention may be used as a utility meter gas valve wrench to shut off or turn on a gas supply. A utility meter gas valve wrench allows the user to open and close a utility meter gas valve by turning the utility meter gas valve stem clockwise or counter-clockwise. A utility meter gas valve may also be known as a gas valve. The said invention uses two parallel structures with sufficient length and clearance between them to fit and operate a utility meter gas valve stem when the said invention user manipulates the said invention to open or close the utility meter gas valve. Referring to FIG. 4, the straight portion of guide one (2) with the arrowed lead line numbered eleven pointing at it is straight parallel structure one (11) and one of the two straight parallel structures that contact a utility meter gas vale stem. The straight portion of guide two (12) of handle one (1) with the arrowed lead line numbered twelve pointing at it, is the second straight parallel structure and one of the two straight parallel structures that contact a utility meter gas vale stem. The clearance between straight parallel structure one (11) of guide one (2) and guide two (12) allows a utility meter gas valve stem to fit between them. Sufficient fitment of a utility meter gas valve stem between straight parallel structure one (11) of guide one (2) and guide two (12) allows the utility meter gas valve stem to be turned by the said invention when the said invention user moves handle one (1).

The said invention may also broadly comprise of a striking/hammer type tool component. FIG. 5 illustrates a major component of the said invention with a striking and/or hammer type tool. Referring to FIG. 5, the flat protruding surface of handle one (1) located between the closed distal end (3) and the fastener/pivot device hole (5a) is the striking/hammer head (17). The striking/hammer type tool component will not be limited to the striking/hammer head (17) design, placement, and/or quantity.

FIG. 6 illustrates a hand (21) holding the said invention (22); furthermore FIG. 6 illustrates a wire's (23) path of travel (24) down the said invention user's arm to the said invention's (22) open cutting area. Referring to FIG. 6, the arm illustrated is divided into three areas; the upper arm area (19), forearm area (20), and the hand (21). A wire (23) is illustrated perpendicular to the upper arm area (19), forearm area (20), hand (21), and said invention (22). The arrowed dotted lead line numbered twenty-four is the wire's (23) path of travel (24). As the said invention user adducts his/her hand (21) towards their body the wire (23) moves across the surface of the upper arm area (19) towards the forearm area (20); the wire (23) then moves across the surface of the forearm area (20) towards the hand (21); the wire (23) then moves across the surface of the hand (21) towards the said invention's (22) guide one (2) and guide two (12); the wire (23) then moves across the surfaces of guide one (2) and guide two (12) and ends in the said invention's open cutting area and stops the wire's (23) path of travel (24); the wire (23) may then be held in the open cutting area and may be cut. The said invention (22) user must manually hand (21) operate the said invention (22) to cut the wire (23). FIG. 6 illustrates how the said invention (22) user may locate and cut wire (23) with only one hand (21) in zero visibility; as long as the said invention (22) user can reach and/or feel the wire (23) with his/her hand (21) and/or arm, then he/she can cut the wire (23) with one hand (21) with zero visibility.

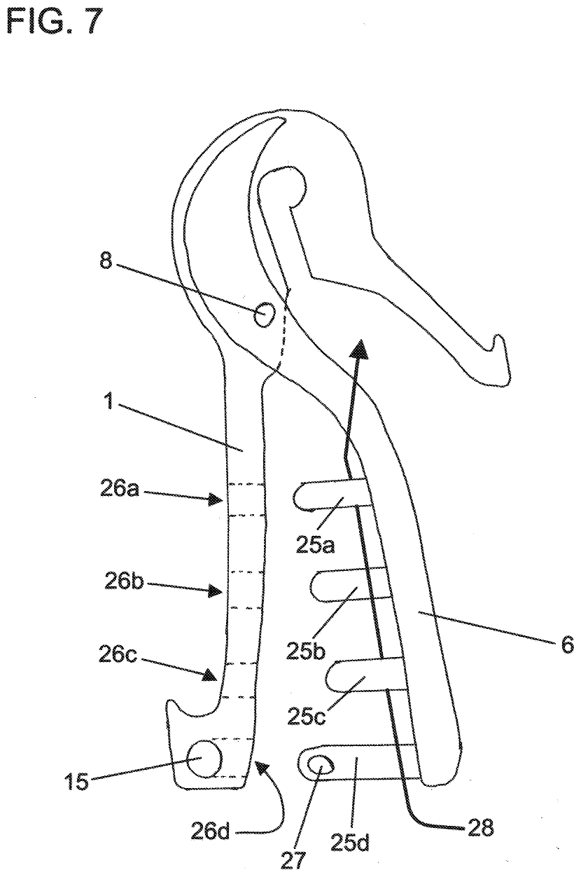

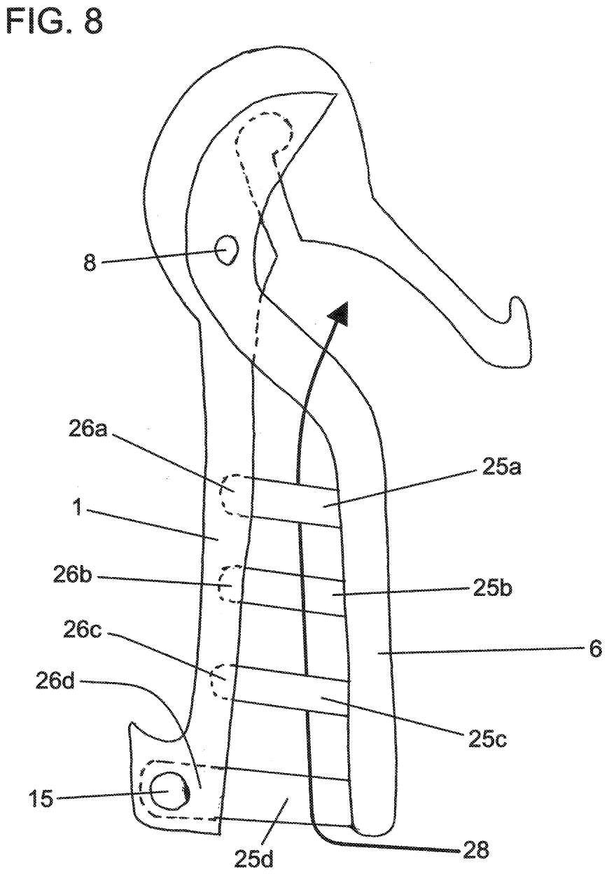

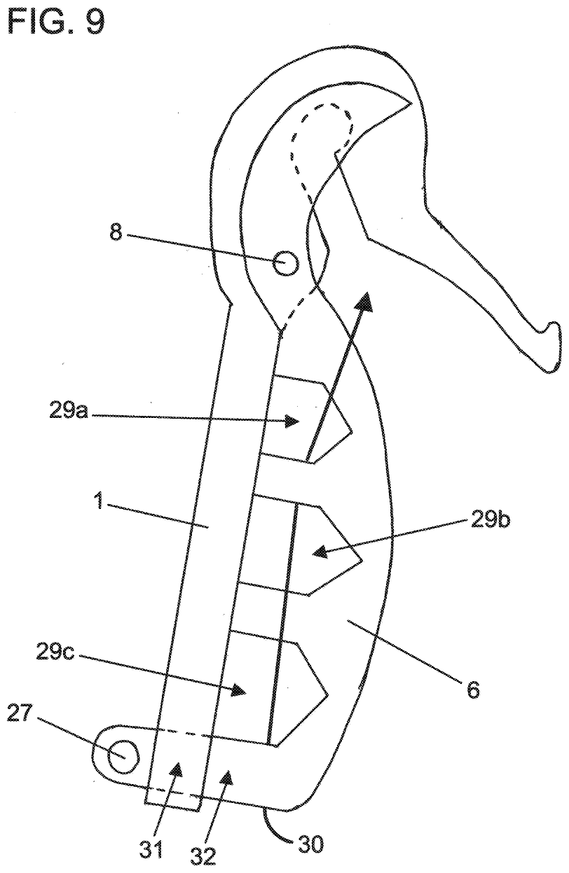

The said invention may have a rope rescue friction descending device component. A rope rescue friction descending device attaches to a rescuer and allows rope to be fed through and/or around the device to produce controlled friction against the rope for a desired descent rate. FIG. 7 illustrates the said invention with the cutting area open and a rope rescue friction descending device component. FIG. 7 is a two dimensional illustration and only illustrates one side of the said invention, the side of the said invention illustrated will be referred to as the front, the opposite side from the front that is not viewable will be referred to as the back. Referring to FIG. 7, handle one (1) and handle two (6) structurally form the components of the rope rescue friction descending device component. Handle one (1) comprises of four cylindrical structures that protrude from handle one (1) towards handle two (2); these cylindrical structural protrusions are friction bar one (25a), friction bar two (25b), friction bar three (25c), and friction bar four (25d). Rope physically contacts friction bar one (25a), friction bar two (25b), friction bar three (25c), and friction bar four (25d) to create friction against the rope for a desired descent rate. Referring to FIG. 7, rope is routed across the front side of friction bar four (25d), then across the back side of friction bar three (25c), then across the front side of friction bar two (25b), then across the back side of friction bar one (25a), and then across the front side of handle two (6); arrowed lead line numbered twenty-eight illustrates the rope route (28) through the said invention. Rope may be routed through less friction bars to achieve a faster descent rate. When the said invention's cutting area is open the clearance between all the friction bars (25a)(25b)(25c)(25d) terminating ends and handle one (1) allows for rope to fit between them, thus allowing for a section of rope to be routed correctly without needing a rope end. Arrowed lead lines numbered twenty-six “a”, twenty-six “b”, twenty-six “c”, and twenty-six “d” point to areas of handle one (1), these areas have two parallel dotted lines that represent holes that cannot be seen by the view illustrated in FIG. 7; furthermore these holes are friction bar hole one (26a), friction bar hole two (26b), friction bar hole three (26c), and friction bar hole four (26d). The openings of the friction bar holes (26a)(26b)(26c)(26d) face the friction bars (25a)(25b)(25c)(25d) and each friction bar hole will align with one individual friction bar when the said invention's cutting area is in the closed position. FIG. 8 illustrates the said invention with the cutting area in the closed position and a rope rescue friction descending device component. Referring to FIG. 8, friction bar one (25a) aligns with and enters friction bar hole one (26a), friction bar two (25b) aligns with and enters friction bar hole two (26b), friction bar three (25c) aligns with and enters friction bar hole three (26c), and friction bar four (25d) aligns with and enters friction bar hole four (25d); furthermore with the cutting area in the closed position, FIG. 8 illustrates a properly routed rope that cannot be dislodged from the said invention unless the entire length of the rope travels through all the friction bars (25a)(25b)(25c)(25d). Arrowed lead line numbered twenty-eight illustrates the rope route (28) through the said invention. The cutting area of the said invention must remain in the closed position while the said invention user is using the said invention to descend. Keeping the cutting area of the said invention in the closed position prohibits the said invention from becoming detached from the rope and/or the rope to become incorrectly displaced. An attaching device attaches the said invention to the said invention user and/or anchor point and locks the said invention cutting area in the closed position; furthermore, a preferred attaching devise is a carabiner rated for the rope rescue descending task being conducted by the said invention user. Referring to FIG. 7, the carabiner attachment hole (27) of friction bar four (25d) is large enough to allow a typical rope rescue carabiner to pass through it and become attached. The carabiner attachment hole (27) aligns with attachment point hole (15) when the cutting area of the said invention is in the closed position. FIG. 8 illustrates the carabiner attachment hole (27) aligned with the attachment point hole (15) when the cutting area of the said invention is in the closed position; furthermore, the alignment of the carabiner attachment hole (27) and the attachment point hole (15) allows a carabiner to attach through the attachment point hole (15) and carabiner attachment hole (27). Referring to FIG. 8, when a carabiner is attached through the attachment point hole (15) and the carabiner attachment hole (27), the said invention may then be attached to the said invention user and/or an anchor point by the carabiner. Referring to FIG. 7, FIG. 8, and FIG. 9, the fastener/pivot device (8) and the said invention user's carabiner must be of sufficient strength to prevent the said invention from coming apart under the stresses of repelling. Referring to FIG. 7 and FIG. 8, all friction bar holes (26a)(26b)(26c)(26d) may be blind holes and/or holes that extend completely through handle one (1); furthermore, the friction bars (25a)(25b)(25c)(25d) may be sufficiently spaced from one another to structurally form a fire hydrant wrench for the purpose of opening and closing fire hydrant valves.

FIG. 9 illustrates one design of the said invention comprising of a rope rescue descending device and fire hydrant wrench all in one component. Referring to FIG. 9, handle one (1), handle two (6), and the fastener/pivot device (8) forms the rope rescue descending device and fire hydrant wrench component. Fire hydrant valve stem shapes are cut into handle two (6), these cut out fire hydrant valve stem shaped areas are represented by arrowed lead lines numbered twenty-nine “a”, twenty-nine “b”, and twenty-nine “c” and structurally form hydrant wrench opening one (29a), hydrant wrench opening two (29b), and hydrant wrench opening three (29c). The proximal end of handle two (6) structurally protrudes towards handle one (1) and ends with a carabiner attachment hole (27). The area of handle two (6) that structurally protrudes towards handle one (1) is arrowed lead line numbered thirty-two (32); furthermore, the arrowed lead line numbered thirty-two (32) area of handle two (6) structurally extends sufficiently enough to pass through an opening in handle one (1) and allows for the carabiner attachment hole (27) to be un-obstructed by handle one (1) when the cutting area of the said invention is in the closed position. The area of the opening in handle one (1) is arrowed lead line numbered thirty-one (31), two parallel dotted lines in the area (31) represent the opening in handle one (1) and illustrates handle two (6) through the opening of handle one (1). A carabiner can be attached through the carabiner attachment hole (27) to lock the cutting area of the said invention in the closed position and/or attach the said invention to a user and/or anchor point. Arrowed line numbered thirty represents the rope route (30) through the said invention when the fire hydrant wrench component is also used as a rope rescue friction descending device.

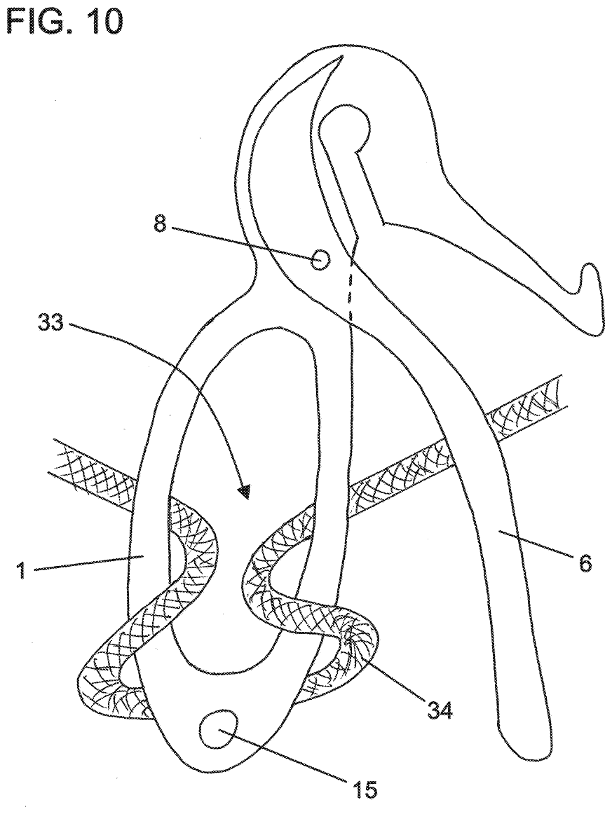

FIG. 10 illustrates the said invention comprising of a rope rescue friction descending device component. Referring to FIG. 10, handle one (1) structurally forms an oval shape, the open area inside the oval shape that handle one (1) structurally forms is represented by arrowed lead line number thirty-three and will be referred to as the open oval area (33). The entire structural perimeter of the open oval area (33) is handle one (1). FIG. 10 illustrates how to route rope (34) through the open oval area (33) of handle one (1) for purpose of using the said invention as a rope rescue friction descending device. FIG. 10 is illustrated as a two dimension view, the side illustrated will be referred to as the front and the side opposite the front that is the same but not viewable will be referred to as the back. To route the rope (34) through the said invention the user needs to make a loop in a section of the rope to be used in descent, the loop then enters through the open oval area (33) of handle one (1) from the back side, the loop is then place over the proximal end of handle one (1) so that it makes contact on the back side of handle one (1). A carabiner attached through the attachment point hole (15) and to the said invention user and/or anchor point keeps the rope loop from slipping off the proximal end of handle one (1) and un-routing back through the open oval area (33). Referring to FIG. 10, the rope rescue friction descending device does not rely on the strength of the fastener/pivot device (8), but only handle one (1) and the carabiner attached through the attachment point hole (15).

The healthcare field uses scissors and/or scalpels to cut umbilical cords of newborn babies. The said invention may be used to safely cut umbilical cords of newborn babies. The closed distal end that forms the distally closed guarded cutting area and the guides would be ideal for emergency medical personnel needing to cut the umbilical cord of a newborn baby in undesirable environments or a nervous father cutting his child's umbilical cord in the clinical setting. Healthcare providers in the clinical setting would also benefit from the said invention. The said invention would provide a safer tool to cut umbilical cords with less chance of injury to patients and medical workers from sharp components of open ended cutting tools such as scissors and scalpels. Sharp areas of the said invention's cutting surfaces and/or ends only contact objects that are in the cutting area of the said invention; furthermore, this safe operational function would also be desirable when cutting a seat belt that is restraining a trapped patient in a vehicle accident.

The said invention design and configuration has been explained in many different configurations, but will not be limited to these designs and/or configurations. The combination of said invention assembly options, components and/or design to be used will be based on the design and/or functionality needs that the said invention is used for.

The use of the word “firefighter” in this document does not designate that the said invention is only to be used by a firefighter and/or the fire service. The word “firefighter” is used to identify a said invention user, but will not limit the possible users and industries the said invention may be used in, the said invention may be used in but not limited to electrical industries, military and/or law enforcement industries, and healthcare industries. The word “wire” in this document does not limit the material and or object to be cut by the said invention; furthermore the said invention may be purposefully used to cut multiple types of material and/or objects. The use of the words “cutting surface” is any surface of the said invention used to contact and separate an object into two or more separate pieces, a flat and/or dull surface for a sharper cutting surface to abut to is a cutting surface. The use of the words “cutting area” is any area between two cutting surfaces. The use of the words “invention” and “said invention” are interchangeable. The words “closed distal end” defines the distal end of the said invention that forms a distally closed cutting area.

As discussed, the invention has many different features, variations and multiple different embodiments. The invention has been described in this application at times in terms of specific embodiments for illustrative purposes and without the intent to limit or suggest that the invention conceived is only one particular embodiment. It is to be understood that the invention is not limited to any single specific embodiments or enumerated variations. Many modifications, variations and other embodiments of the invention will come to mind of those skilled in the art to which this invention pertains, and which are intended to be and are covered by both this disclosure. It is indeed intended that the scope of the invention should be determined by proper interpretation and construction of the disclosure, including equivalents, as understood by those of skill in the art relying upon the complete disclosure at the time of filing.

I claim:

1. A hand operated cutting tool comprising of:
a first component comprising of a proximate end and a distal end, a proximately disposed first handle that structurally forms a first guide disposed distally that terminates into a first cutting surface that then terminates into a second guide, and at least one pivot axis;
a second component comprising a proximate end and a distal end, a proximately disposed second handle and a distally disposed second cutting surface, and at least one pivot axis;
at least one fastener/pivot component for pivotably connecting components comprising a pivot axis, and being disposed between the handles and cutting surfaces so that at least one handle pivotably moves at least one cutting surface from an open cutting area position to a closed cutting area position and/or a closed cutting area position to an open cutting area position.

2. At least one component of the hand operated cutting tool of claim 1, further comprising a wire stop.

3. At least one component of the hand operated cutting tool of claim 1, further comprising an attachment point.

4. At least one component of the hand operated cutting tool of claim 1, further comprising a hand stop.

5. At least one component of the hand stop of claim 4, further comprising a pry tool.

6. At least one component of the hand stop of claim 4, further comprising a spanner wrench.

7. At least one component of the hand operated cutting tool of claim 1, further comprising a pry tool.

8. At least one component of the pry tool of claim 7, further comprising a spanner wrench.

9. At least one component of the hand operated cutting tool of claim 1, further comprising a spanner wrench.

10. At least one component of the spanner wrench of claim 9, further comprising a pry tool.

11. At least one component of the hand operated cutting tool of claim 1, further comprising a window punch.

12. At least one component of the hand operated cutting tool of claim 1, further comprising a striking/hammer tool.

13. At least one component of the hand operated cutting tool of claim 1, further comprising a gas valve wrench.

14. At least one component of the hand operated cutting tool of claim 1, further comprising a rope rescue fiction descending device.

15. At least one component of the rope rescue friction descending device of claim 14, further comprising a fire hydrant wrench.

16. At least one component of the hand operated cutting tool of claim 1, further comprising a fire hydrant wrench.

17. At least one component of the fire hydrant wrench of claim 16, further comprising a rope rescue friction descending device.

18. At least one component of the hand operated cutting tool of claim 1, further comprising a fire sprinkler head wedge.

19. At least one component of the hand operated cutting tool of claim 1, further comprising a multi-tool.

20. At least one component of the hand operated cutting tool of claim 1, further comprising a tension/friction mechanism.
